(19) United States
(12) Patent Application Publication
(10) Pub. No.: US 2014/0056452 A1
(43) Pub. Date: Feb. 27, 2014

(54) Portable Device with Power Management Controls

(71) Applicants: Brian Moss, Skehacreggaun (IE); Howard R. Samuels, Newton, MA (US); Joseph Wayne Palmer, Greensboro, NC (US); Alain Valentin Guery, Andover, MA (US); James M. Lee, Northborough, MA (US)

(72) Inventors: Brian Moss, Skehacreggaun (IE); Howard R. Samuels, Newton, MA (US); Joseph Wayne Palmer, Greensboro, NC (US); Alain Valentin Guery, Andover, MA (US); James M. Lee, Northborough, MA (US)

(73) Assignee: Analog Devices, Inc., Norwood, MA (US)

(21) Appl. No.: 13/590,448

(22) Filed: Aug. 21, 2012

(51) Int. Cl. H04R 25/00

(52) U.S. Cl. 381/323

(57) ABSTRACT

A wearable device has a motion detector configured to detect motion of the device and produce a motion signal relating to motion of the device, a contact sensor configured to detect if the device is in contact with an object and produce a contact signal relating to whether the device is in contact with an object, and a controller operatively coupled with the motion detector and the contact sensor. The controller is configured to switch between on and off-states as a function of at least one of the motion signal and contact signal. The device also has a sound transducer or other transducer operatively coupled with the controller. The controller is configured to change the state of the sound transducer between on and off-states in response to receipt of the motion signal, and the contact signal.

### RELATED APPLICATION

This patent application is related to U.S. patent application Ser. No. 13/114,193, filed on May 24, 2011, naming Howard R. Samuels as inventor, and entitled, “HEARING INSTRUMENT CONTROLLER,” the disclosure of which is incorporated herein, in its entirety, by reference.

### FIELD OF THE INVENTION

The invention generally relates to portable devices and, more particularly, the invention relates to managing the power usage of portable devices.

### BACKGROUND OF THE INVENTION

Portable devices commonly are powered by an integral power source, such as a rechargeable or replaceable battery. As the art adds new features and optimizes existing features, portable devices demand more power. To meet this increasing need, those in the art may simply use larger batteries. Doing this, however, is contrary to another widespread trend in modern electronics; namely, device miniaturization.

This problem is especially problematic with hearing instruments (e.g., hearing aids and cochlear implant sound processors), as well as with portable body-worn health, fitness, or vital signal monitoring devices. In fact, many hearing instruments unnecessarily remain on when not in use, consequently wasting power. For example, a user may place their hearing instrument on a night table for the evening and forget to turn it off. Naturally, this causes the battery to drain the entire night, reducing battery lifetime.

### SUMMARY OF THE INVENTION

In accordance with one embodiment of the invention, a wearable device has a motion detector configured to detect motion of the device and produce a motion signal relating to motion of the device, a contact sensor configured to detect if the device is in contact with an object and produce a contact signal relating to whether the device is in contact with an object, and a controller operatively coupled with the motion detector and the contact sensor. The controller is configured to switch between on and off-states as a function of at least one of the motion signal and contact signal. The device also has a system component operatively coupled with the controller. The controller is configured to change the state of the system component between on and off-states in response to receipt of the motion signal, and the contact signal.

The controller may be configured to turn the system component to the on-state (from the off-state) before processing the contact signal and after processing the motion signal. The controller may be configured to maintain the system component in an on-state after the controller processes the contact signal when the contact signal has information indicating that the device is in contact with the object. Conversely, the controller may be configured to return the system component to the off-state after the controller processes the contact signal when the contact signal has information indicating that the device is not in contact with the object. Alternatively, the controller may be configured to turn the system component to the on-state (from the off-state) after processing both the motion signal and the contact signal. In that case, the system component may be in an off-state until turned to the on-state by the controller.

In some embodiments, the contact sensor is configured to change from an off-state to an on-state in response to receipt of a motion signal indicating motion. The contact sensor then determines if the device is in contact with the object. The contact sensor is configured to forward a contact signal to the controller if it detects the device is in contact. After receipt of the contact signal indicating the device is in contact, the controller responsively may change the state of the system component from an off-state to an on-state.

Among other things, the controller may include one of a digital signal processor, an ASIC, and a microprocessor. Also, the system component may include a MEMS microphone, a speaker, or other component. The device may further include hearing instrument housing, where the component includes a microphone and a speaker at least in part within the hearing instrument housing.

Moreover, the controller may be configured to change the state of the system component from an on-state to an off-state in response to receipt of the contact signal indicating that the device is not in contact with the object. In that case, the contact sensor also may determine if the device is in contact with the object after the motion detector generates a motion signal indicating no motion.

The controller may be configured to be in an off-state at least a portion of the time that the motion detector is detecting motion. Moreover, the controller may be configured to change from an off-state to an on-state after receipt of a motion signal indicating motion.

In accordance with another embodiment of the invention, a hearing instrument has a housing, a motion detector (within the housing) configured to detect motion and produce a motion signal relating to motion of the detector, and a contact sensor configured to detect device physical contact of the housing with a user and produce a contact signal relating to housing contact with a user, and a processor operatively coupled with both the motion detector and the contact sensor. The hearing instrument also has a microphone operatively coupled with the processor. The processor is configured to switch between on and off-states as a function of at least one of the motion signal and contact signal. In addition, the processor is configured to change the state of the microphone between on and off-states in response to receipt of the motion signal and the contact signal indicating.

In accordance with other embodiments of the invention, a method of controlling power provides a wearable device having a system component and a connecting region for removably connecting with a user. Next, the method determines one or both of a) if the wearable device is moving, and b) if the wearable device is being worn by a user. If the system component is in an on-state, then the method a) causes the system component to change to an off-state if the device is determined not to be worn by a user, and b) causes the system component to remain in the on-state if the device is determined to be worn by a user. Conversely, if the system component in an off-state, then the method a) causes the system component to remain in the off-state if the device is determined not to be moving, b) causes the system component to remain in the off-state if the device is determined to be moving and determined not to be worn by a user, and c) causes the system component to change to an on-state if the device is determined to be moving and determined to be worn by a user.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a plurality of different types of wearable devices—hearing aids in this case—that may incorporate illustrative embodiments of the invention.

FIG. 2 schematically shows an example of a cochlear implant that may incorporate illustrative embodiments of the invention.

FIG. 3 schematically shows various interior components of a hearing instrument incorporating illustrative embodiments of the invention.

FIG. 4 schematically shows a process for controlling hearing instrument functionality based upon inertial signals and contact signals.

### DESCRIPTION OF ILLUSTRATIVE EMBODIMENTS

In illustrative embodiments, a wearable device, such as a hearing instrument, controls its power consumption based upon both whether the device is moving and whether it is being worn by a user. To that end, illustrative embodiments have a motion sensor/motion detector and a contact sensor or proximity sensor that coordinate with a controller to control device power consumption. For example, if the device is not moving but being worn by a user, it may remain in, or change to, an on-state. As another example, if the device is not moving and not being worn by a user, it may remain in, or change to, an off-state. Details of illustrative embodiments are discussed below.

Various embodiments apply to hearing instruments, which, in this context, are either hearing aids or cochlear implant systems (also referred to as “cochlear implants,” or “cochlear implant sound processors”). People thus use hearing instruments because of a medical need, such as a limited ability to hear the spoken word or other normally audible signals. This is in contrast to listening devices that are not considered hearing instruments, such as speakers, headphones (e.g., headphone sold by Apple Inc. under the trademark EARBUDS), cellular telephones, headsets, and televisions. Accordingly, the term “hearing instrument” is used herein with reference to hearing aids and cochlear implant systems only. Hearing instruments are identified in this document as “hearing instruments 10,” hearing aids are identified by reference number 10A, and cochlear implants are identified by reference number 10B.

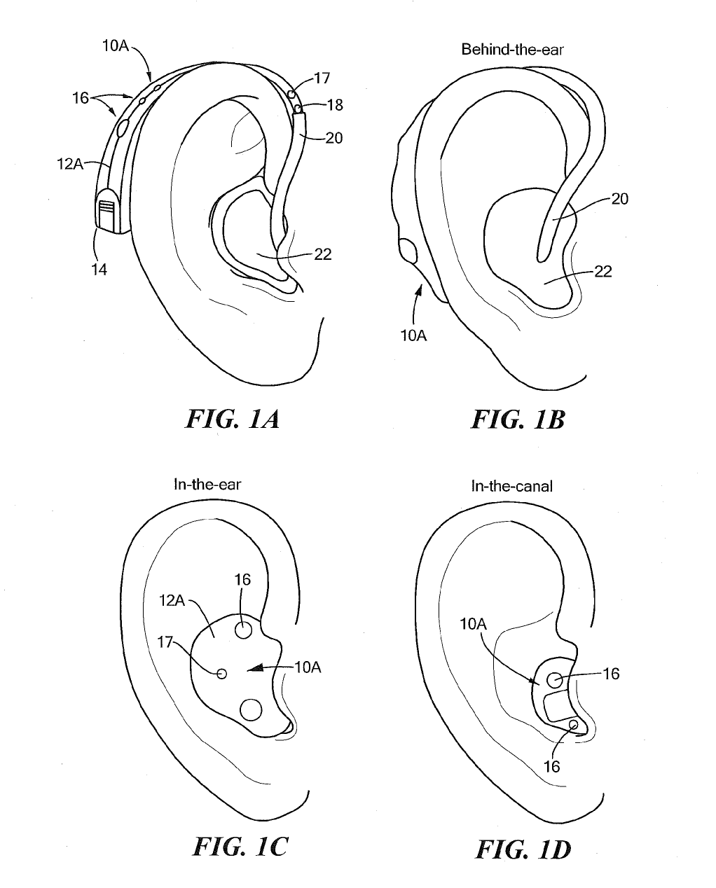

To those ends, FIG. 1 illustratively shows three different types of hearing aids 10A that may incorporate illustrative embodiments of the invention. Drawings A and B of FIG. 1 show different “behind the ear” types of hearing aids 10A that, as their name suggests, have a significant portion secured behind the ear during use. In contrast, drawings C and D show hearing aids 10A that do not have a component behind the ear. Instead, these types of hearing aids 10A mount within the ear. Specifically, drawing C shows an “in-the-ear” hearing aid 10A which, as its name suggests, mounts in-the-ear, while drawing D shows an “in-the-canal” hearing aid 10A which, as its name suggests, mounts more deeply in the ear—namely, in the ear canal.

With reference to drawing A of FIG. 1, the intelligence and logic of the behind the ear type of hearing aid 10A lies primarily within a housing 12A that mounts behind the ear, i.e., the housing 12A is considered to have a connecting region for connecting to the ear. To that end, the housing 12A forms an interior chamber that contains internal electronics for processing audio signals, a battery compartment 14 (a powering module) for containing a battery that powers the hearing aid 10A, and mechanical controlling features 16, such as knobs, for controlling the internal electronics. In addition, the hearing aid 10A also includes a first sound transducer, such as a microphone 17, for receiving audio signals, and a second sound transducer, such as a speaker 18, for transmitting amplified audio signals received by the microphone 17 and processed by the internal electronics. A hollow tube 20 directly connected to the end of the hearing aid 10A, right near the speaker 18, channels these amplified signals into the ear. To maintain the position of this tube 20 and mitigate undesired feedback, the hearing aid 10A also may include an ear mold 22 (also part of the body of the hearing aid 10A) formed from soft, flexible silicone molded to the shape of the ear opening.

Among other things, the hearing aid 10A may have logic for optimizing the signal generated through the speaker 18. More specifically, the hearing aid 10A may have certain program modes that optimize signal processing in different environments. For example, this logic may include filtering systems that produce the following programs:
normal conversation in a quiet environment,
normal conversation in a noisy environment,
listening to a movie in a theater, and
listening to music in a small area.

The hearing aid 10A also may be programmed for the type of hearing loss of a specific user/patient. It thus may be programmed to provide customized amplification at specific frequencies. Indeed, discussion of these different programs with regard to a hearing aid 10A are illustrative. Other body worn devices may have their own device/use specific logic that performs corresponding optimization based on variables, such as the environment or anticipated use.

The other two types of hearing aids 10A typically have the same internal components, but in a smaller package. Specifically, the in-the-ear hearing aid 10A of drawing C has a flexible housing 12A with the internal components and molded to the shape of the ear opening. In particular, among other things, those components include a microphone 17 facing outwardly for receiving audio signals, a speaker (not shown in this figure) facing inwardly for transmitting those signals into the ear, and internal logic for amplifying and controlling performance.

The in-the-canal hearing aid 10A of drawing D typically has all the same components, but in a smaller package to fit in the ear canal. Some in-the-canal hearing aids 10A also have an extension (e.g., a wire) extending out of the ear to facilitate hearing aid removal.

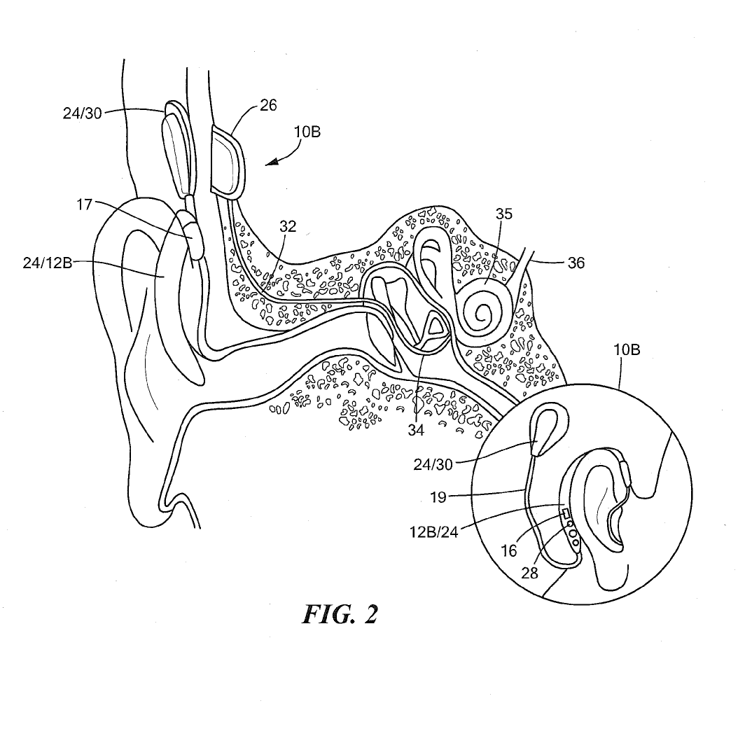

FIG. 2 schematically shows the second noted type of hearing instrument 10, a cochlear implant 10B. At a high level, a cochlear implant 10B has the same function as that of a hearing aid 10A; namely, to help a person hear normally audible sounds. A cochlear implant 10B, however, performs its function in a different manner by having an external portion 24 that receives and processes signals, and an implanted portion 26 physically located within a person's head to directly stimulate that person's auditory nerve 36.

To those ends, the external portion 24 of the cochlear implant 10B has a behind the ear portion with many of the same components as those in a hearing aid 10A behind the ear portion. The larger drawing in FIG. 2 shows this behind the ear portion as a transparent member since the ear covers it, while the smaller drawing of that same figure shows it behind the ear.

Specifically, the behind the ear portion includes a housing/body 12B that contains a microphone 17 for receiving audio signals, internal electronics for processing the received audio signals, a battery, and mechanical controlling knobs 16 for controlling the internal electronics. Those skilled in the art often refer to this portion as the “sound processor” or “speech processor.” A wire 19 extending from the sound processor connects with a transmitter 30 magnetically held to the exterior of a person's head. The speech processor communicates with the transmitter 30 via the wire 19.

The transmitter 30 includes a body having a magnet (not shown) that interacts with the noted implanted metal portion 26 to secure it to the head, wireless transmission electronics (not shown) to communicate with the implanted portion 26, and a coil (not shown) to power the implanted portion 26 (discussed below). Accordingly, the microphone 17 in the sound processor receives audio signals, and transmits them in electronic form to the transmitter 30 through the wire 19, which subsequently wirelessly transmits those signals to the implanted portion 26.

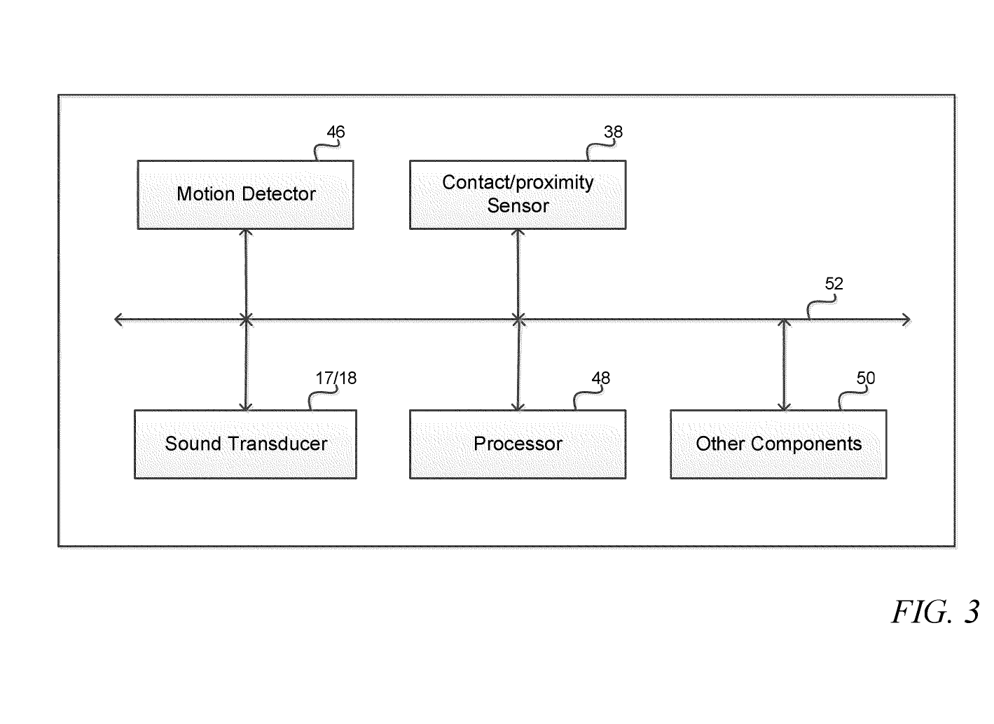

The implanted portion 26 thus has a receiver with a microprocessor 48 (see FIG. 3) to receive compressed data from the external transmitter 30, a magnet (not shown) having an opposite polarity to that in the transmitter 30 both to hold the transmitter 30 to the person's head and align the coil(s) within the external portion 24/transmitter 30, and a coil (not shown) that cooperates with the coil in the exterior transmitter 30. The coil in the implanted portion 26 forms a transformer with the coil of the external transmitter 30 to power its own electronics. A bundle of wires 32 extending from the implanted portion 26 passes into the ear canal and terminates at an electrode array 34 mounted within the cochlea 35. As known by those skilled in the art, the receiver transmits signals to the electrode array 34 to directly stimulate the auditory nerve 36, thus enabling the person to hear sounds in the audible range of human hearing. Moreover, like the other embodiments, this type of hearing instrument is considered to have a connecting portion or region for connecting with the user.

Prior art hearing instruments, including those shown in FIGS. 1 and 2, typically had mechanical components 16 (e.g., knobs, switches, and dials) on its body to turn the hearing aid 10A on and off. For example, the battery compartment often functioned as the power switch, while a knob controlled volume. These mechanical components 16 also may control the volume of the output sound (e.g., the amplitude of the amplified audio signal of a hearing aid 10A), the program selection, and other functions. FIG. 1 explicitly shows some of these mechanical components 16 on the different types of hearing aids 10A.

As a person who has used hearing instruments 10, one of the inventors realized the difficulties of these mechanical controls 16 firsthand. Specifically, as these devices become smaller and smaller, so do the mechanical switches and knobs 16. This is exacerbated when used by a typical user, such as a senior citizen, who often has reduced manual dexterity. Moreover, mechanical knobs 16 often are a principal source of device failure by breaking, and by providing exposed areas for moisture and contaminants access into the housing 12A or 12B.

Illustrative embodiments reduce or eliminate these mechanical features 16 by embedding an inertial sensor 46 (e.g., see FIG. 3) somewhere within the hearing instrument 10. Specifically, the internal circuitry can respond to inertial signals—rather than signals from tiny and fragile mechanical controls 16—to control hearing instrument operation. For example, the volume can be increased or decreased, or the program can be changed, when the inertial sensor 46 detects a tap on certain parts of the instrument 10, or on the person's head.

This phenomenon was discovered despite the countervailing drive to reduce the available space within hearing instruments 10, thus limiting the ability for a hearing instrument 10 to contain an extra component, such as an inertial sensor 46. As discussed below, certain inertial sensors can be sized small enough to have a negligible impact on this limited space. This is particularly important in hearing instruments, which have little room for extra components (e.g., when compared to larger mobile devices, such as mobile telephones, tablets, laptops, or other larger systems). In addition, rather than draw more power, which is antithetical to current hearing instrument trends, the inertial sensor 46 can control the power draw at least to minimize its power footprint in the instrument 10 to a negligible level.

The inventors further realized that coupling the inertial sensor 46 with a contact sensor and/or proximity sensor (both identified herein by reference number “38”) should further improve power management. Accordingly, instead of reducing components, the inventors added yet further components—one or more contact or proximity sensors 38, in addition to the one or more inertial sensors 46—which can have a significant impact on power consumption. In fact, various embodiments only keep the contact sensor 38 in an on-state for a specific amount of time after the accelerometer detects motion, or when the hearing instrument 10 already is in an on-state. Accordingly, the inertial sensor 46 may remain on when the device is in the off-state. As such, the inertial sensor 46 preferably draws a very low current/low power.

Illustrative embodiments may use any of a variety of different types of inertial sensors. Among others, low power, low profile, low-G one-axis, two-axis, or three-axis accelerometers should suffice. For example, the ADXL346 accelerometer (a 3-axis accelerometer), distributed by Analog Devices, Inc. of Norwood Mass., may suffice, although its current draw may be greater than 25 microamps. As another example, the ADXL362 accelerometer, also distributed by Analog Devices, Inc. should suffice. Its current draw may be only about 300 nanoamps in an active sleep mode, thus minimizing power draw. As yet another example, a wafer level, chip scale package having a low power, low-G MEMS accelerometer also may suffice. Accelerometers drawing between about 200 nanoamps and 5 microamps would suffice. Other embodiments may use gyroscopes or other MEMS devices (e.g., pressure sensors).

Illustrative embodiments therefore use the inertial sensor 46 to either augment the mechanical components 16, or completely replace them to improve reliability. The inertial sensor 46 and contact sensor 38 thus also enable intelligent power management, reducing the likelihood that the instrument 10 will unnecessarily remain “on” when not in use. Accordingly, the mere act of placing the hearing instrument 10 onto a person's head can cause the electronics to energize. In a corresponding manner, the mere act of placing a hearing instrument 10 onto a table (for preselected amount of time), such as a night table, can cause an automatic power down of the electronics (e.g., almost all of the electronics). There would be no need for the user to remember to turn off the hearing instrument 10 at the end of the day, or to struggle manipulating a small and fragile mechanical switch.

In addition, as another example, a user simply may tap the top of a hearing instrument 10 to increase the volume, or tap the back of the hearing instrument 10 to decrease the volume. A user also may tap another portion of the hearing instrument 10 to cycle through the different program modes. Of course, the hearing instrument 10 can be configured to respond to different patterns of tapping and types of tapping and thus, the discussion of tapping on specific areas is for illustrative purposes only. Moreover, this functionality also can be controlled by specific, pre-defined head movements.

In-the-ear hearing aids 10A and in-the-canal hearing aids 10A have only one exposed surface to tap, however, which can present certain challenges. Various embodiments, however, are programmed to convert taps on the person's head into volume control, programming control, or other hearing instrument functions. Embodiments that convert tapping patterns to controls also provide a satisfactory means for controlling the instrument 10. For example, two quick successive tabs can increase the volume, while two slow taps can decrease the volume.

Other embodiments may use the accelerometer for fall detection. In particular, an accelerometer generates a unique signal during a fall. For example, that signal may detect a zero-G event, followed by a sudden stop and/or a short duration bounce. Accordingly, after detecting a fall, the device may have a transmitter/logic to transmit a “fall” signal to another device, notifying a third party of the fall.

In addition to hearing instruments 10, the wearable device can include or implement other wearable devices, such as sporting and exercise devices, entertainment devices, and medical devices. For example, some such wearable devices may include vital signs monitoring devices, such as heart rate sensors, temperature sensors, or oxygen sensors, sports watches, Bluetooth devices, wireless or wired headphones, 3D glasses, portable music systems, pedometers, and other devices. Each of these wearable devices has a body connecting region for removably connecting with a user. For example, as a connecting region, a heart monitoring device may have a strap that spans across a user's chest, or a sleeve that slips on a user's arm or leg. The strap may have buckles, VELCRO, or other fastener, and support the heart monitoring device with its noted power saving functionality. Moreover, in various embodiments, like a hearing instrument, the wearable device has a transducer. For example, some transducers may include thermal transducers, optical transducers, or gas transducers.

Discussion of hearing instruments 10 thus is by example only. Accordingly, all embodiments are not limited to hearing instruments 10.

FIG. 3 schematically shows a block diagram of a hearing instrument 10 incorporating illustrative embodiments of the invention. The logic shown in this figure, some of which is noted above, can be incorporated into any of the hearing instruments 10 shown in FIGS. 1 and 2. Accordingly, illustrative embodiments can augment the functions of the mechanical controllers 16 of the hearing instrument 10 shown in those figures.

To that end, the hearing instrument 10 includes the above noted housing 12A/12B containing a motion sensor/detector 46 (referred to as a “motion sensor” or “motion detector”) configured to detect motion of the hearing instrument 10, and a contact or proximity sensor 38 configured to detect if the hearing instrument 10 is in contact with, or in close proximity with, an object, such as a person.

Among other things, the motion detector 46 may include one or more inertial sensors, such as the accelerometers and gyroscopes discussed above. As known by those skilled in the art, an inertial sensor, such as an accelerometer, generates a signal in response to a pre-specified type of movement, such as an acceleration. This signal typically includes information indicating whether the device is moving, and the amplitude and direction of such movement.

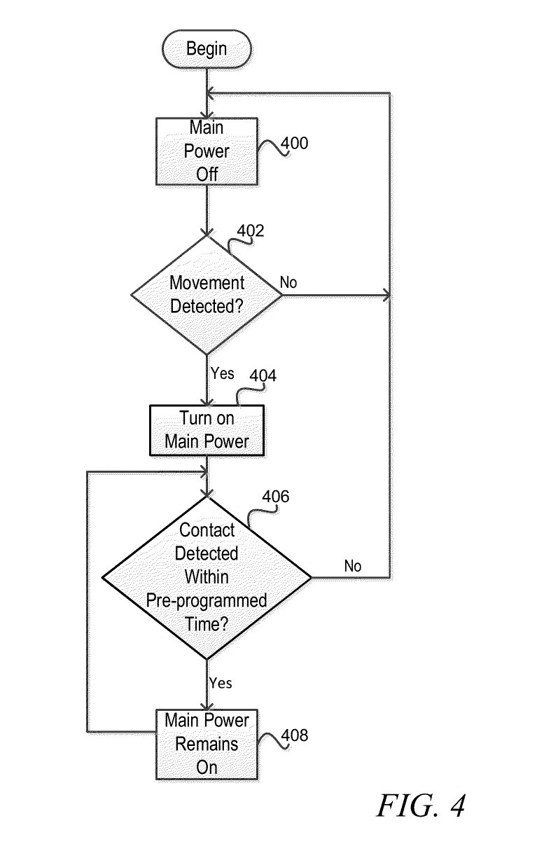

The contact or proximity sensor 38 may include sensors that detect either or both direct contact or close proximity to the hearing instrument 10. In fact, the embodiments described herein used with a contact sensor 38 instead may use a proximity sensor 38, and vice versa. Some embodiments may use both a contact sensor 38 and a proximity sensor 38. Among other things, the contact or proximity sensor 38 may be implemented as a capacitance-to-digital converter within the housing 12A/12B. For example, the contact or proximity sensor 38 may be implemented using one or more model number AD7156 capacitive converters, distributed by Analog Devices, Inc. of Norwood Mass. In a manner similar to the motion detector 46, the contact or proximity sensor 38 generates a proximity signal, or contact signal, after it detects proximity or contact with an object, such as a person. This proximity/contact signal also includes information indicating whether there is contact/proximity, or no contact/proximity. As discussed in detail below regard to FIG. 4, illustrative embodiments also use this proximity signal to improve power efficiency of the hearing instrument 10. It should be noted that the terms “proximity signal” and “contact signal” may be used to denote the same type of signal based on the context of its use.

Other embodiments may use a number of different types of components for detecting proximity or contact. For example, the hearing instrument 10 may use a heat detector, or a light detection device. Accordingly, like the other components, discussion of one type of contact sensor 38 is not intended to limit all embodiments of the invention.

The hearing instrument 10 also includes a number of other components, including a controller 48 (also referred to herein as a “processor 48” and mentioned above) for controlling operation of many of the electronics within the hearing instrument 10, and one or more sound transducers 17, 18 for converting acoustic signals to electric signals (i.e., microphones 17), and electric signals to acoustic signals (i.e., speakers 18). The processor 48, which has the logic described below, may include a microprocessor, digital signal processor, application specific integrated circuit, or other conventionally known circuitry capable of performing the required functions. As discussed below in greater detail, in various embodiments, the processor 48 controls power efficiency based upon the motion signal and the proximity signal. Moreover, the hearing instrument 10 may have only one processor 48, or other processors 48 that perform different functions as well as those described herein.

Any of a number of different types of sound transducers commonly used for these applications should suffice. For example, some embodiments may use MEMS microphones (e.g., electret MEMS devices, non-electret MEMS devices, or piezoelectric devices) for converting acoustic signals into electronic signals, and other electromechanical speakers for converting electronic signals and to acoustic signals. Among others, some embodiments may use the model number ADMP521 MEMS microphone, also distributed by Analog Devices, Inc. Other embodiments, such as those implemented as a cochlear implant, may not use speakers.

Of course, for simplicity, the hearing instrument 10 in FIG. 3 only shows some of the components that will ultimately be in the final product. As known by those skilled in the art, the hearing instrument 10 device will include many other components (shown schematically by box 50), depending upon the application. For example, among many other components, the hearing instrument 10 may include an amplifier (not shown) to amplify converted acoustic signals received by the microphone, power circuitry (not shown) to power the various components, and a transmitter (not shown) for transmitting information wirelessly to a receiver (e.g., in the above noted implementation using the fall detection) or to control functionality (e.g., to/from remote controls, binaural control, and/or assistive listening device systems).

All of these components communicate by means of some interconnection medium, schematically shown as a single bus 52. It should be noted that this single bus 52 merely shows the operative connection of the various components in a schematic manner and, accordingly, is not intended to suggest one type of connection. Those skilled in the art can interconnect the components any of a number of different ways.

FIG. 4 shows a process for controlling wearable device functionality based upon inertial signals and proximity signals. For simplicity and as an example, this process is discussed in the context of the hearing instrument 10. Those skilled in the art should understand, however, that various embodiments may be practiced in other portable devices, such as wristwatches, pedometers, etc. . . . Accordingly, discussion of a hearing instrument 10 is but one of many potential applications.

Hardware, software (e.g., a computer program product having a tangible medium with code thereon), or some combination thereof may perform the process described in FIG. 4. Moreover, this process shows a few of the many steps of the process of controlling hearing instrument functionality. Accordingly, discussion of this process should not be considered to include all necessary steps, and the steps could be performed in a different order.

The process begins at step 400, in which the main power to the hearing instrument 10 is off (i.e., in an “off-state”). Accordingly, in various embodiments, the processor/controller 48, contact sensor 38, power system, and other main components are all unpowered, or, at most, in a stand-by state (i.e., less than full power but not powered down) using minimal power. The motion detector 46, however, is on (i.e., in an “on-state”), monitoring the system for any non-negligible movement. Since the system is off, the motion detector 46 operates independently of the processor 48. If the motion detector 46 does not detect motion (step 402), then the process loops back to step 400 to maintain the power in its off-state. For example, the hearing instrument 10 may be on a person's night table.

In some embodiments, the motion detector 46 continuously monitors for movement, while in other embodiments, the motion detector 46 wakes every set time period (e.g., every second) to check for movement. Continuous monitoring may be preferred if using an accelerometer with a very low power consumption; e.g., one that draws a current of 5 microamps or less when monitoring. In some such embodiments, such as that using the ADXL362, the motion detector 46 is an accelerometer with a drain current of about 1.4 microamps when fully on, and as low as about 300 nanoamps when in active sleep mode. Specifically, during active sleep mode, the accelerometer is capable of monitoring movement and triggering an interrupt or other action as necessary (see below discussion), which causes subsequent steps to take place.

This loop between steps 400 and 402 continues until the motion detector 46 detects motion. Continuing with the above example, the person may have bumped into the night table in the dark, or may have removed the hearing instrument 10 from the night table and attached it to his/her ear. At that point, if motion is detected, the motion detector 46 generates a motion signal having information indicating that the hearing instrument 10 has moved. That information simply may be in the form of an interrupt signal connected to a specified port of the processor 48. Accordingly, generation of this motion signal causes the system to responsively turn on the main power to the hearing instrument 10 (step 404), turning on at least the processor 48 and the contact sensor 38.

The process of turning on the main power creates a natural turn-on delay (i.e., the time to turn on and initialize the processor 48) before moving to the next step. Specifically, after the main power (or at least power to some components) is turned on, the process continues to step 406, which determines if the hearing instrument 10 is in contact, or close proximity, to an object (i.e., in this example, a person). To that end, the processor 48 may determine if it receives a contact signal, from the contact sensor 38, having information indicating contact or proximity (i.e., the contact signal indicating either 1. close proximity or contact, or 2. close proximity and no contact).

Various embodiments, however, do not immediately check for contact or proximity. Instead, this step may have a pre-programmed amount of time to wait for a contact or proximity signal from the contact sensor 38. That pre-programmed time is selected based upon the anticipated use of the device. For example, when implemented in the hearing instrument 10, that time may be selected and programmed based upon the amount of time it typically takes for a person to first pick up the hearing instrument 10 and attach it to his/her ear (e.g., 20 seconds, 30 seconds, or however long studies may suggest).

If the contact signal does not indicate contact (or proximity, whichever the case may be) within the preprogrammed time, then the process loops back to step 400, turning off the main power. To that end, the processor 48 may initiate shut-down processes for most components. The motion detector 46 still remains on to monitor motion, however, while most or all of the other components 50 either completely power off, or convert back to stand-by mode.

Conversely, if the contact signal does indicate contact within the preprogrammed time at step 406, then the process continues to step 408, in which the main power remains on. To that end, the processor 48 continues with its normal on-state processes. This creates another loop back to step 406, which again determines if there is contact. This case does not necessarily require a delay before checking for contact (i.e., after it has been determined to be in contact with a person). Instead, the process checks for contact either continuously, or once every time interval (e.g., once every 5-60 seconds, or whatever is deemed suitable by the designer). To that end, some embodiments program the processor 48 to check (via the contact sensor 38, while other embodiments may use other components for this function.

When the system is on, the motion detector 46 is no longer necessary for controlling power consumption. Thus, the hearing instrument 10 may power it down. Alternative embodiments, however, continue to use the motion detector 46 for other functions while the hearing instrument 10 is on. For example, the hearing instrument 10 may use the motion detector 46 for fall detection.

Yet other embodiments continue to use the motion detector 46 for power conservation purposes while the hearing instrument 10 is in an on-state. Specifically, to reduce power consumption when in the on-state, the system may turn off the contact sensor 38 and yet leave the motion detector 46 in an on-state. This should improve power performance particularly when the motion detector 46 draws much less power than the contact sensor 38.

In that case, the motion detector 46 can monitor movement while the hearing instrument 10 is in an on state. For example, among other ways, the motion detector 46 may continuously monitor, or poll every set period. If it detects no motion for at least some other period of time (e.g., no motion for at least five or ten minutes), then the processor 48 will turn on the contact sensor 38. When on, the contact sensor 38 generates a signal indicating whether or not there is contact (or proximity). If there is contact, then the processor 48 maintains the power in the on-state. Conversely, if it receives a contact signal indicating no contact, then the processor 48 turns the power to an off-state. Accordingly, because the contact sensor 38 can remain off while the hearing instrument 10 is worn, this alternative method may further reduce power consumption. The power savings of this and other embodiments is a function of the power draw of the components used, and the anticipated type of device (e.g., a hearing instrument 10 or wrist mounted device).

Using both the motion and contact sensors 46 and 38 during the on-state (in this embodiment) can be especially useful if a person is still/not moving for a long period. For example, the person may be in a movie theater watching a movie. Without contact or proximity sensors 38, the processor 48 may undesirably turn off the hearing instrument 10 while the person sitting still, watching a movie. In a corresponding manner, without the motion detector 46, the hearing instrument 10 may detect proximity or contact with an irrelevant object (e.g., a night table), thus unnecessarily maintaining the hearing instrument 10 in an on-state.

As noted above, some embodiments vary the steps. For example, rather than turning on the main power at step 404, some embodiments turn on the processor 48 and contact sensor 38 only, or at least fewer components than those turned on during a full system turn-on. In that case, step 408 changes to “Main Power Turns On or Remains On.” Specifically, in that case, the processor 48 causes the other system components to turn on after determining that there is contact. The loop of steps 406 and 408 thus continues until no further contact.

Alternatively, some embodiments may maintain the contact sensor 38 in an on-state even when the hearing instrument 10 is in an off-state. While this is expected to drain battery power faster than other embodiments, it still could present a reasonable solution. For example, if the proximity sensor 38 draws very low power, like that drawn by the motion detector 46, it may provide a reasonable option. The type of sensor, as well as the anticipated application, should inform those in the art as to whether this is a beneficial option.

The processor 48 generally controls the processes described above. Some embodiments, however, may not use the processor 48 in all such steps. For example, the motion detector 46 may directly connect with a power-on/off port on the contact sensor 38. In that case, the contact sensor 38 may turn on (or remain on) when it receives a motion signal indicating motion, and/or turn off (or remain off) when receiving a motion signal indicating no motion. Some of those embodiments also control the state of the processor 48 using signals from both of those sensors.

In some embodiments, one or more of the sensors may generate signals that are not strongly indicative of the condition they are measuring. For example, the proximity sensor 38 may detect various levels or proximity—some strongly indicating a proximity or contact, while others less strong. In the latter case, the signal may be a false positive (e.g., the user may have placed the device 10 on a table with the proximity sensor face down). The processor 48 thus may read this latter signal and respond accordingly.

For example, the processor 48 may perform additional steps to determine if the detected proximity is the type it is programmed to act upon (e.g., proximity with a person), and if not, turn off the device 10. To that end, the processor 48 may interrogate other sensors for confirmation (e.g., a temperature sensor), or cause the proximity sensor 38 to take further readings. The processor 48 further may cause another component 50 to produce some visual or audible indicia if a condition it is programmed to manage is not met (e.g., if the device is not properly connected to the user).

Accordingly, illustrative embodiments use two different sensors to control the state of the hearing instrument 10. When turning to an on-state from an off-state, use of both sensors should provide improved power performance. When turning off from an on-state, however, only one sensor can be used (i.e., the contact sensor 38) to achieve power savings, although both still can be used for those purposes. Moreover, in various embodiments, when in an on-state, the hearing instrument 10 may use the contact sensor 38 only. When in an off-state, the hearing instrument 10 may use the motion detector 46 only. This intelligent use of components should improve system performance, reducing power consumption.

Although the above discussion discloses various exemplary embodiments of the invention, it should be apparent that those skilled in the art can make various modifications that will achieve some of the advantages of the invention without departing from the true scope of the invention.

What is claimed is:

1. A wearable device comprising:
a motion detector configured to detect motion of the device, the motion detector producing a motion signal having information relating to motion of the device;
a contact sensor configured to detect if the device is in contact with an object, the contact sensor producing a contact signal having information relating to whether the device is in contact with an object;
a sound transducer; and
a controller operatively coupled with the motion detector, the contact sensor, and the sound transducer;
the controller configured to switch between on and off-states as a function of at least one of the motion signal and contact signal,
the controller configured to change the state of the sound transducer from the off-state to the on-state using information in both the motion signal and the contact signal, the controller configured to change the state of the sound transducer from the on-state to the off-state using information in the contact signal without using information in the motion signal.

2. The wearable device as defined by claim 1 wherein the controller is configured to turn the sound transducer to the on-state from the off-state before processing the contact signal and after processing the motion signal, the controller configured to maintain the sound transducer in an on-state after the controller processes the contact signal when the contact signal comprises information indicating that the device is in contact with the object.

3. The wearable device as defined by claim 1 wherein the controller is configured to turn the sound transducer to the on-state from the off-state before processing the contact signal and after processing the motion signal, the controller configured to return the sound transducer to the off-state after the controller processes the contact signal when the contact signal comprises information indicating that the device is not in contact with the object.

4. The wearable device as defined by claim 1 wherein the controller is configured to change from an off-state to an on-state in response to receipt of a motion signal indicating motion, the controller being configured to remain on for a preprogrammed period of time after receipt of the motion signal changing its state, the controller turning off after the preprogrammed period of time if the contact sensor does not generate a signal indicating contact during the period of time.

5. The wearable device as defined by claim 1 wherein the contact sensor is configured to change from an off-state to an on-state in response to receipt of a motion signal indicating motion, the contact sensor configured to determine if the device is in contact with the object after the contact sensor transitions to the on-state from an off-state, the contact sensor configured to forward a contact signal with information indicating contact to the controller if it detects the device is in contact, the controller changing the state of the sound transducer from an off-state to an on-state after receipt of the contact signal indicating the device is in contact.

6. The wearable device as defined by claim 1 wherein the controller comprises at least one of a digital signal processor, an ASIC, and a microprocessor.

7. The wearable device as defined by claim 1 wherein the motion detector is configured to be in an on-state and the contact sensor is configured to be in an off-state when the controller is in the off-state, further wherein motion detector is configured to be in an off-state and the contact sensor is configured to be in an on-state when the controller is in the on-state.

8. The wearable device as defined by claim 1 wherein the contact sensor is configured to determine if the device is in contact with the object after the motion detector generates a motion signal indicating no motion.

9. The wearable device as defined by claim 1 wherein the sound transducer comprises a MEMS microphone.

10. The wearable device as defined by claim 1 further comprising a hearing instrument housing, the sound transducer including a microphone and a speaker at least in part within the hearing instrument housing.

11. The wearable device as defined by claim 1 wherein the controller is configured to be in an off-state at least a portion of the time that the motion detector is detecting motion.

12. The wearable device as defined by claim 1 wherein the controller is configured to change from an off-state to an on-state after receipt of a motion signal indicating motion.

13. A hearing instrument comprising:
a housing;
a motion detector configured to detect motion, the motion detector being within the housing and configured to produce a motion signal relating to motion of the detector;
a contact sensor configured to detect physical contact of the hearing instrument with a user, the contact sensor being configured to produce a contact signal relating to contact with a user;
a processor operatively coupled with the motion detector and the contact sensor; and
a microphone operatively coupled with the processor,
the processor being configured to switch between on and off-states as a function of at least one of the motion signal and contact signal,
the processor configured to change the state of the microphone between on and off-states in response to receipt of the motion signal and the contact signal.

14. The hearing instrument as defined by claim 13 wherein the processor is configured to turn the microphone to the on-state from the off-state before processing the contact signal and after processing the motion signal, the processor configured to maintain the microphone in an on-state after the processor processes the contact signal when the contact signal comprises information indicating contact with the user.

15. The hearing instrument as defined by claim 13 wherein the processor is configured to turn the microphone to the on-state from the off-state before processing the contact signal and after processing the motion signal, the processor configured to return the microphone to the off-state after the processor processes the contact signal when the contact signal comprises information indicating no contact with the user.

16. The hearing instrument as defined by claim 13 wherein the processor is configured to turn the microphone to the on-state from the off-state after processing both the motion signal and the contact signal, the microphone being in an off-state until turned to the on-state by the processor.

17. The hearing instrument as defined by claim 13 wherein the contact sensor is configured to change from an off-state to an on-state in response to receipt of a motion signal indicating motion, the contact sensor configured to determine if there is contact with the user after transitioning to the on-state, the contact sensor configured to forward a contact signal to the processor if it detects contact, the processor changing the state of the microphone from an off-state to an on-state after receipt of the contact signal indicating contact.

18. A method of controlling power in a wearable device, the method comprising:
providing a wearable device having a sound transducer, a motion detector for detecting motion of the device, a contact sensor for determining if the device is being worn by a user, and a connecting region for removably connecting with a user;
determining, using at least one of the motion detector and the contact sensor of the wearable device, one or both of a) if the wearable device is moving, and b) if the wearable device is being worn by a user;
if the sound transducer is in an on-state, then a) causing the sound transducer to change to an off-state if the device is determined not to be worn by a user, and b) causing the sound transducer to remain in the on-state if the device is determined to be worn by a user;
if the sound transducer is in an off-state, then a) causing the sound transducer to remain in the off-state if the device is determined to be moving and determined not to be worn by a user, b) causing the sound transducer to change to an on-state if the device is determined to be worn by a user and moving.

19. The method as defined by claim 18 wherein the wearable device comprises a processor for controlling the state of the sound transducer, at least one of the motion detector and contact sensor controlling the state of the processor, the processor controlling the state of the sound transducer.

20. The method as defined by claim 18 wherein the wearable device comprises a hearing instrument.

21. The method as defined by claim 18 wherein determining comprises a) determining if the wearable device is moving and, if determined to be moving, 2) determining if the device is being worn by a user within a predetermined period of time after detecting movement.

22. A wearable device comprising:
a body having a connecting region for removably connecting with a user;
a motion detector, coupled with the body, configured to detect motion of the device, the motion detector producing a motion signal having information relating to motion of the device;
a contact sensor, coupled with the body, configured to detect if the device is in contact with an object, the contact sensor producing a contact signal having information relating to whether the device is in contact with an object;
a transducer coupled with the body; and
a controller, coupled with the body and operatively coupled with the motion detector, the contact sensor, and the transducer;
the controller configured to switch between on and off-states as a function of at least one of the motion signal and contact signal,
the controller configured to change the state of the transducer from the off-state to the on-state using information in both the motion signal and the contact signal, the controller configured to change the state of the transducer from the on-state to the off-state using information in the contact signal without using information in the motion signal.

23. The wearable device as defined by claim 22 wherein the controller is configured to turn the transducer to the on-state from the off-state before processing the contact signal and after processing the motion signal, the controller configured to maintain the transducer in an on-state after the controller processes the contact signal when the contact signal comprises information indicating that the device is in contact with the object.

24. The wearable device as defined by claim 22 wherein the controller is configured to turn the transducer to the on-state from the off-state before processing the contact signal and after processing the motion signal, the controller configured to return the transducer to the off-state after the controller processes the contact signal when the contact signal comprises information indicating that the device is not in contact with the object.

25. The wearable device as defined by claim 22 wherein the controller is configured to change from an off-state to an on-state in response to receipt of a motion signal indicating motion, the controller being configured to remain on for a preprogrammed period of time after receipt of the motion signal changing its state, the controller turning off after the preprogrammed period of time if the contact sensor does not generate a signal indicating contact during the period of time.

26. The wearable device as defined by claim 22 wherein the contact sensor is configured to change from an off-state to an on-state in response to receipt of a motion signal indicating motion, the contact sensor configured to determine if the device is in contact with the object after the contact sensor transitions to the on-state from an off-state, the contact sensor configured to forward a contact signal with information indicating contact to the controller if it detects the device is in contact, the controller changing the state of the transducer from an off-state to an on-state after receipt of the contact signal indicating the device is in contact.
